(19) United States
(12) Patent Application Publication
(10) Pub. No.: US 2010/0141938 A1
(43) Pub. Date: Jun. 10, 2010

(54) METHOD AND APPARATUS FOR DETECTION OF ANALYTES

(75) Inventors: Ayan Banerjee, Bangalore (IN); Sandip Maity, Bangalore (IN); Matthew Damian Pietzykowski, Clifton Park, NY (US); Umakant Damodar Rapol, Bangalore (IN)

Correspondence Address: GENERAL ELECTRIC COMPANY;GLOBAL RESEARCH, ONE RESEARCH CIRCLE, PATENT DOCKET RM. BLDG. K1-4A59, NISKAYUNA, NY, 12309, US

(73) Assignee: GENERAL ELECTRIC COMPANY, Shenectady, NY (US)

(21) Appl. No.: 12/331,713

(22) Filed: Dec. 10, 2008

(51) Int. Cl. G01N 21/03

(52) U.S. Cl. 356/246

(57) ABSTRACT

A microfluidic detection system is provided. The system comprises a device for illuminating a microfluidic sample comprising an analyte, wherein illumination from the illuminating device is modulated on and off at a determined frequency, a gated phase-sensitive detector that detects, one or more wavelengths emitting from the analyte, at a determined frequency, and a control device that coordinates the modulating frequency of the illumination and the detecting frequency of the detector.

### BACKGROUND

The invention relates to analyte detection, and more particularly to analyte detection in microfluidic systems.

Typically, laser induced fluorescence (LIF) detection techniques are employed for protein detection. LIF is the optical emission from molecules that have been excited to higher energy levels by absorption of electromagnetic radiation. The main advantage of fluorescence detection compared to absorption measurements is the greater sensitivity achievable because the fluorescence signal has very low background noise. LIF provides selective excitation of the analyte to avoid interferences. LIF is useful for many applications such as the study of the electronic structure of molecules and to make quantitative measurements of analyte concentrations. Analytical applications include but are not limited to monitoring gas-phase concentrations in the atmosphere, flames, and plasmas; and remote sensing using light detection and ranging (LIDAR).

However, in microfluidic applications, LIF suffers from poor signal to noise ratio (S/N) due to small quantity of the samples available. Also, background fluorescence of the materials employed (quartz, for example) interferes with the signal from the analyte.

Therefore, detection techniques are needed for protein detection that are capable of detecting smaller volumes of samples with high sensitivity.

### BRIEF DESCRIPTION

In one embodiment, a microfluidic detection system is provided. The system comprises a device for illuminating a microfluidic sample comprising an analyte, wherein illumination from the illuminating device is modulated on and off at a determined frequency, a gated phase-sensitive detector that detects, one or more wavelengths emitting from the analyte, at a determined frequency, and a control device that coordinates the modulating frequency of the illumination and the detecting frequency of the detector.

In another embodiment, a microfluidic detection system for detecting a signal corresponding to an analyte is provided. The system comprises a device for illuminating a microfluidic sample comprising an analyte, wherein illumination from the illuminating device is modulated on and off at a determined frequency, a gated phase-sensitive detector that detects one or more wavelengths emitting from the analyte at a determined frequency, and a control device that coordinates the modulating frequency of the illumination and the detecting frequency of the detector.

In yet another embodiment, a detection system for detecting a signal corresponding to an analyte is provided. The system comprises a sample support comprising a sample detection zone, a device for illuminating the sample in the detection zone, wherein the illuminating devices modulates on and off, and a gated phase-sensitive detector for detecting the signal at a determined frequency when the illuminating device is off.

In another embodiment, a method for signal detection of an analyte is provided. The analyte is present in a sample provided on a support. The method comprises illuminating the sample, ceasing illumination of the sample after a determined time interval, and after a time delay period, begin detecting a signal emitted from the sample at one or more locked-in detection frequencies.

### DRAWINGS

FIG. 1 is a schematic of an embodiment of a microfluidic detection system employing a gated phase-sensitive detection;

FIG. 2 is a graphical representation of an example of gated phase-sensitive detection;

FIG. 3 is an example of gated phase-sensitive detection configuration in a microfluidic system;

FIG. 4 is a flow chart illustrating an example of the method for gated phase-sensitive detection in a microfluidic system; and

FIG. 5 is a comparative graphical representation of an examples of gated phase-sensitive detection and phase-sensitive detection.

These and other features, aspects, and advantages of the present invention will become better understood when the following detailed description is read with reference to the accompanying drawings in which like characters represent like parts throughout the drawings, wherein:

### DETAILED DESCRIPTION

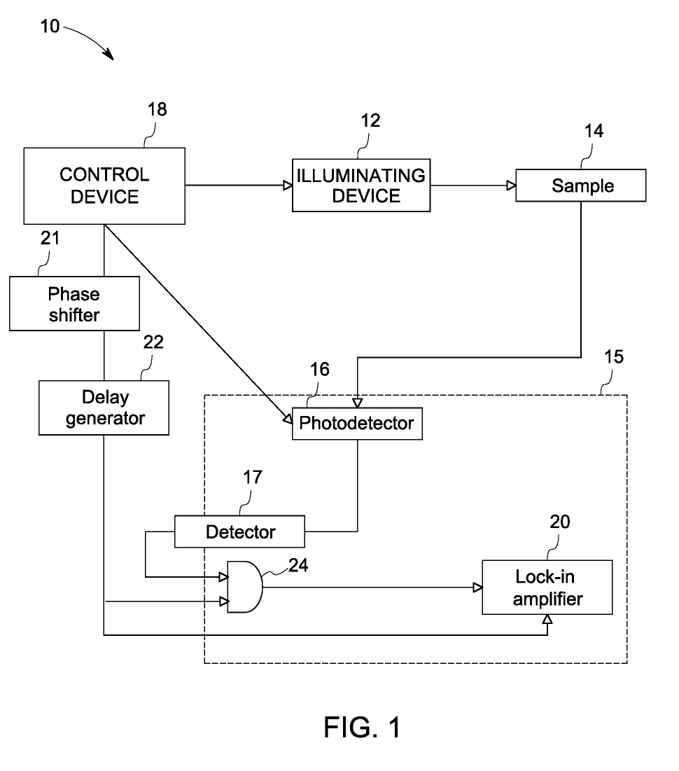

One or more embodiments of the system of the invention comprise a device for illuminating a sample disposed in a microfluidic device. The illumination from the illuminating device modulates on and off at a determined frequency. In one embodiment, the illuminating device modulates on and off at the determined frequency or the modulating frequency. For example, the illuminating device may be electronically switched off and switched on at the determined frequency. In other embodiment, the illumination from the illuminating device may be allowed to reach the sample at determined intervals corresponding to the determined frequency. For example, an intermittent illumination device, such as a mechanical chopper (for example, a fan) may be disposed between the illuminating device and the sample, so as to allow the sample to be exposed to the illumination at the determined frequency. The system also comprises a gated phase-sensitive detector that detects one or more wavelengths emitted by the analyte. The gated phase-sensitive detector produces signals that are time delayed and phase shifted from the scattering signals of the illuminating device, for example. In certain embodiments, the detector may include a photodetector, and a lock-in amplifier. As used herein, the term “lock-in amplifier” refers to a type of amplifier that can extract a signal with a known carrier wave from extremely noisy environment (S/N may be 60 dB or less). Lock-in amplifiers may use mixing, through a frequency mixer, to convert the signal's phase and amplitude to a DC signal, or time-varying low-frequency voltage signal. Lock-in amplifiers may be used to measure the amplitude and phase of signals buried in noise. As shown in FIG. 1, the lock-in amplifier 20 acts as a narrow bandpass filter which removes at least a part of the undesired noise while allowing through the signal which is to be measured.

Further, a control device may form part of the microfluidic detection system, where the control device coordinates the modulating frequency of the illumination from the illuminating device and the detecting frequency of the detector. For example, the control device may either control the on and off modulating frequency of the illuminating device, or the control device may control the speed of rotation of a mechanical chopper, such as a fan.

In one embodiment, the microfluidic detection system may be employed to detect proteins, for example. Fluorophores, such as dyes, or phosphors, in a size range of few nanometers to few micrometers may be used as moieties for proteins. In one example, the decay time of the moieties may be less than about 10 nanoseconds. For some healthcare processes the available sample volumes may be very small, on the order of micro-pico liters. In such cases, a high signal to noise ratio (S/N) is desired for these small sample volumes, so as to make sure that the sample is correctly analyzed, or detected for the suspected analytes. As will be appreciated, small sample volumes may make it difficult to increase the amount of signal. Therefore, in one embodiment, the S/N may be increased by decreasing the noise. It should be noted that gated detection facilitates reduction of the background noise. For example, the background due to scattering from the illuminating device as well as the frequency noise of the illuminating device or the white noise may be reduced by detecting while the illuminating device is off or the radiation from the illuminating device is blocked using a mechanical device, such as the optical chopper. In certain embodiments, the illuminating device and the detector may modulate at about the same frequency of modulation, but with a time delay, such that the illuminating device is off during detection, and the detector is off when the illuminating device is illuminating the sample. In this way, the noise frequency is limited to only the modulation frequency.

FIG. 1 is an example of a microfluidic detection system 10 employing a gated phase sensitive detection technique. In the illustrated embodiment, the detection system 10 comprises an illuminating device 12, which illuminates a microfluidic sample 14 disposed in a detection zone of a microfluidic device at a determined frequency. That is, the illumination from the illuminating device reaches the sample at definite intervals defined by the determined frequency. In one embodiment, the illuminating device 12 modulates on and off at the determined frequency. In this embodiment, the illuminating device 12 may be electronically switched on and off. In one example, the modulation frequency of the illuminating device 12 may be in a range from about 10 KHz to about 30 KHz. In another embodiment, a mechanical chopper may be disposed between the illuminating device 12 and the microfluidic sample 14, such that the mechanical chopper allows the sample 14 to be illuminated at the determined frequency. The illuminating device 12 may include, but is not limited to, a laser, a light emitting diode (LED), or a fluorescent lamp (such as a xenon lamp), or combinations thereof. In some embodiments, fiber optics may be used to connect the different devices of the detection system 10. For example, fiber optics may be used to connect the illuminating device 12 to the sample when the illuminating device 12 is configured to modulate on and off.

In the illustrated embodiment, the detector 15 is a gated phase-sensitive detector. The detector 15 detects signals from the analyte and produces gated phase-sensitive signals. In one example, sensitivity of the gated phase-sensitive detector is greater than about 5 nanovolts. That is, the detector is adapted to measure signals as low as 5 nanovolts. The detector 15 includes a photodetector 16, a detection circuitry 17 and a lock-in amplifier 20. Further, the detector 15 includes a logic gate 24 that allows the gated signal to reach the lock-in amplifier 20, only when the source is off. In one example, the photodetector 16 may include a photodiode such as an avalanche photodiode, or a charge-coupled device (CCD). The detector 15 detects the signals at a particular frequency referred to as the detection frequency, which is determined by the control device 18. In one embodiment, the detection frequency is determined at least in part based on the frequency of modulation of the illuminating device 12. In one embodiment, the detector may detect only when the sample is not being illuminated by the illuminating device 12. For example, the detector 15 may detect when the illuminating device 12 is electronically switched off, or when the chopper interrupts the light beam from the illuminating device 12 from reaching the sample.

The analyte signals are detected by the photodetector 16 and passed through the detection circuitry 17. The detection circuitry 17 may convert current signal to voltage signal. Also, the detection circuitry may amplify the signal received from the photodetector 16. In embodiments, where the lock-in amplifier 20 is adapted to receive current signal, the detection circuitry may not be required. Also, in embodiments where the photodetector 16 includes a built in amplifier, an additional amplifier may not be required in the detection circuitry 17.

A control device 18 may be employed for coordinating the modulating frequency of the illumination from the illuminating device 12 and the detection frequency of the detector 15 by sending a modulating signal to the illuminating device 12 and to the detector 15. The modulating signal to the detector 15 is passed through a phase shifter 21 and a delay generator 22 to produce a signal that is delayed with respect to the reference-modulating signal of the illumination. The delayed signal is then mixed with the detection signal produced by the detection circuitry 17 through a logic gate 24, such as an AND gate, to produce a delayed detected signal. This delayed or gated detected signal is then fed to the lock-in amplifier 20 to obtain a gated phase-sensitive signal.

Advantageously, in a lock-in detection, the signal is detected at a single frequency, thus eliminating broadband frequency noise. Also, lock-in amplifier enables parallel phase-sensitive detection at the output of a microfluidic sample. That is, in case of microfluidic device having a plurality of channels that comprise a sample, the different microfluidic channels may be modulated at different frequencies to get different signals with a time delay between each of the signals. Although not illustrated, in certain embodiments, processing of the signal output by detector 15 may be done by electronic circuitry, which may include low pass filter, and current or voltage amplifier.

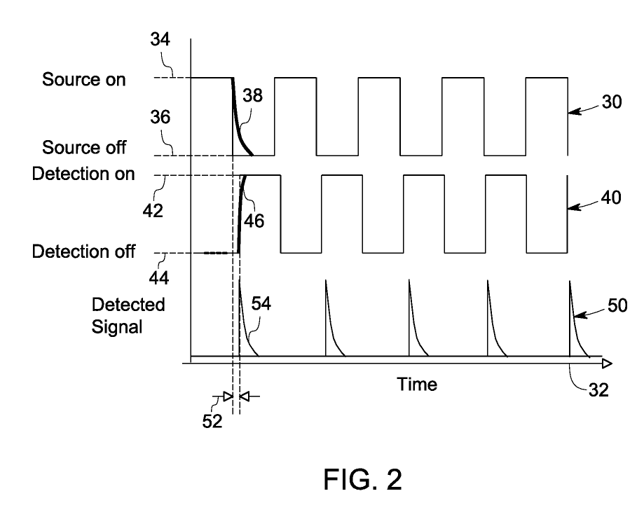

FIG. 2 illustrates the concept of gated phase-sensitive detection, where the detection is carried out when the source is off. Graph 30 illustrates the modulation pattern of the illuminating source or the on and off pattern of the source with respect to time (abscissa 32). The source on condition is represented by reference numeral 34 and the source off condition is represented by reference numeral 36. As illustrated by the curve 38, there is typically a source fall time associated with the source, which represents the amount of time taken by the radiation from the source to die down after the source is switched off. For example, the source fall time for fluorescent illumination is the time it takes for the fluorescence from the source to reduce to undetectable levels.

Graph 40 represents the modulation pattern of the detector. The detector detects at instances represented by the reference numeral 42, and the detector is switched off at instances represented by the reference numeral 44. The detector has an associated rise time 46, which is the time taken by the detector to be able to detect signals from the analyte after the detector is switched on. As illustrated, the detection frequency of the detector is phase shifted and time delayed from that of the source, to enable detection during the source off mode and with a time delay. As illustrated by graph 50, the detector rise time results in a delay 52 for detecting the analyte signal. The delay 52 accounts for the time when there is no detection from the detector. The detector detects the signal after the delay time 52 and before the illumination from the source reduces to insignificant levels. In other words, the detection is carried out in interval 54 that is the fall time of the source and the rise time of the detector. The delay time may be decided based on the amount of time that the source takes to switch off. Since the detection is carried out when the source is off, the fluorescence from the source correspondingly dies down relative to the fluorescence decay time. Given that the detector has a finite rise time, to be able to collect maximum signal, the detector rise time needs to be much smaller than the fluorescence decay time. In one embodiment, where the detector comprises a photodiode, a rise time of the photodiode is in a range from about 2 nanoseconds to about 5 nanoseconds.

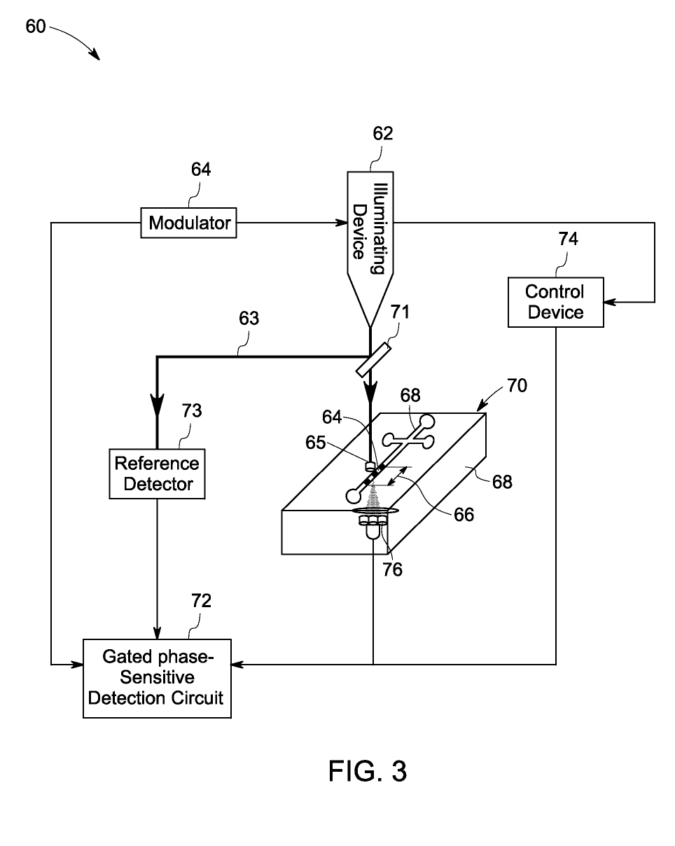

FIG. 3 is an example configuration of the microfluidic detection system 60 for detecting a signal corresponding to an analyte. The system 60 comprises a device 62 for illuminating a microfluidic sample 64 comprising an analyte disposed in a sample support, such as a detection zone 66, of a microfluidic channel 68 of the microfluidic device 70. The illuminating device 62 modulates on and off at a determined frequency. In one example, the illuminating device 62 may be a light emitting diode emitting at 470 nanometers wavelength. In another example, the illuminating device 62 is a laser emitting at 532 nanometers wavelength. The illuminating device 62 may be coupled to the sample by employing a single mode optical fiber 63, for example. The system 60 comprises a modulator 62 to modulate the illuminating device 62 on and off, or the illumination from device 62 on and off. A beam splitter 71 may be positioned between the illuminating device 62 and the microfluidic device 70. The beam splitter 71 may split the beam from the illuminating device 62 into two or more portions, such that one portion of the beam illuminates the sample, and the other portion is directed to a reference detector 73. The frequency of the signal to be measured, and hence the bandpass region of the filter, is set by a reference signal, which has to be supplied to the lock-in amplifier along with the unknown signal. The reference signal must be at the same frequency as the modulation of the signal to be measured.

Further, a lens 65 may be employed between the illuminating device 62 and the microfluidic sample 64 to shape and focus the beam through the sample analyte. In one example, a cylindrical lens may be employed at the end of the optical fiber 63. A second lens may also be employed to refocus the beam returning from the sample analyte and directed towards the photodetector of the gated phase-sensitive detection circuitry 72. The returning beam may be is refocused by a lens to the gated phase-sensitive detection circuitry 72. Alternatively, a concave mirror at the opposite end of the sample analyte may serve to refocus the beam into the return fiber. In some embodiments, the photodetector and the device supporting the sample analyte may be directly coupled, thereby eliminating the need for an optic fiber that would attenuates the optical signal received by the photodetector. The photodetector of the gated phase-sensitive detection circuitry 72 may be any device which responds to the magnitude of the optical intensity and optical wavelength received from the sample analyte.

In the illustrated embodiment, the illuminating device 64 illuminates the analyte disposed in the microfluidic device 70 along a direction of detection. In other words, the gated phase-sensitive detector 72 detects, at least in part, along a direction line that is in-line with the illuminating device 64 direction line. In one embodiment, the photodetector may be in the direction of excitation of the analyte.

The gated phase-sensitive detector 72 detects one or more wavelengths emitting from the analyte at a determined frequency. In one embodiment, the detector 72 detects when the illuminating device 62 is off. In one embodiment, the gated phase-sensitive detector 72 comprises a heterodyne lock-in amplifier. Further, the system 60 includes a control device 74 that coordinates the modulating frequency of the illuminating device 62 and the detecting frequency of the detector 72. Control device 74 coordinates the modulation of the illuminating device and the detecting frequency of the detector based at least in part on a determined time delay interval between when the illumination source is on and when the detector begins detecting.

The system 60 further comprises a low-wavelength pass optical filter 76 disposed between the sample detection zone 66 and the detector 72. Although not illustrated, the output from the detector may be fed to a computer for further processing.

The output of the gated phase-sensitive detection circuitry 72 could be any electronic signal or parameter change due to the changes of receiving optical intensity and wavelength. For example, the output of the gated phase-sensitive detection circuitry 72 may be a voltage, a current, a resistance, or a capacitance change. In one embodiment, the gated phase-sensitive detection circuitry 72 may incorporate a cooler (not shown) that is useful for reducing noise such as thermal noise, excess noise and dark current noise. Optionally, a current source may be used to supply bias current to the detector if required. For example, while employing a photo-varistor detector, a bias voltage source may be required. However, while employing a photovoltaic detector, the additional bias voltage may not be required.

In certain embodiments, a pre-amplifier may be employed. The pre-amplifier is a low noise amplifier that amplifies the signal and converts the signal to a voltage output from the gated phase-sensitive detection circuitry 72. If the signal output is a voltage, then the pre-amplifier may be a typical amplifier that directly amplifies the voltage. If the output from the gated phase-sensitive detection circuitry 72 is an impedance change signal, then the pre-amplifier must convert the signal to a voltage signal, and provide a voltage output.

In one embodiment, the voltage output of the pre-amplifier is applied to a lock-in amplifier. The lock-in amplifier may be a phase-sensitive amplifier such as an analog lock-in amplifier or a digital lock-in amplifier if the noise is greater than the signal.

A computer may be used to process and display the signals. The computer may be used to generate a variety of quantitative and qualitative measures. For example, in quantitative measurements, the X-axis represents time and the Y-axis may represent percentage of concentration of one fluid in another fluid. As another example, in the qualitative analysis, the spectrum is scanned, and the spectrum of transmission and absorption is determined. Such a system could be useful in fluorescence spectroscopy of different biomolecules, as well as for in-vitro or in-vivo imaging applications for clinical as well as other industrial systems.

In addition, the computer may have a spectrum library, which stores the information regarding the spectral characteristics of various elements or chemical compounds. This spectrum library may be used to identify unknown samples by comparing the spectral information received from an unknown sample with spectral patterns retained in the library, and identification of the unknown substance may be made by comparison.

In one example, a determined time delay interval is about 1 nanosecond to about 2.5 nanoseconds and the concentration of analyte is greater than or equal to about 3 nanomoles per litre of solution. In this example, a signal to noise ratio is enhanced by a factor in a range from about 3 to about 10.

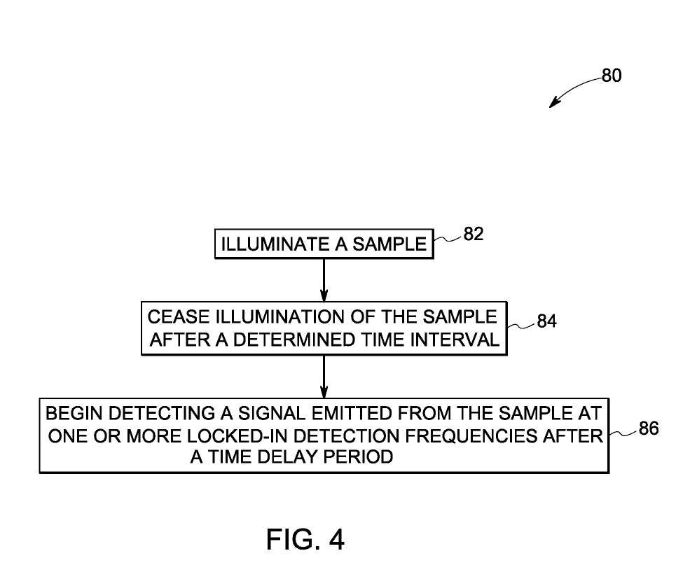

FIG. 4 illustrates a flow chart 80 of a method for analyte signal detection in a sample provided on a support. At block 82, the method comprises illuminating the sample. At block 84, illumination of the sample is ceased after a determined time interval. At block 86, after a time delay period, detection is initiated to detect a signal emitted from the sample at one or more locked-in detection frequencies. In one embodiment, the signal emitted from the sample is filtered prior to sending the signal to the detector. In embodiments where the sample comprises a fluorescent probe, the determined time interval may be greater than or equal to a fluorescence lifetime of the fluorescent probe. In one embodiment, the sample comprises a protein.

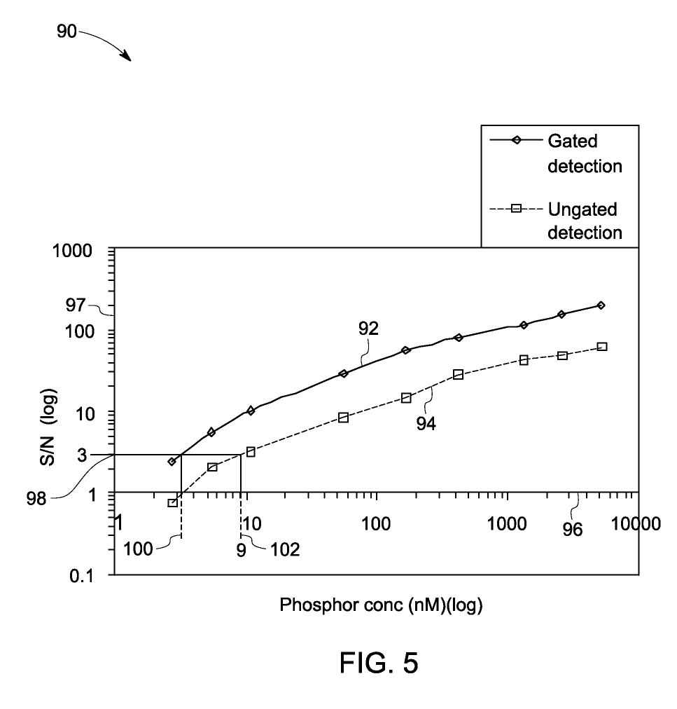

FIG. 5 illustrates a graph 90 having curves 92 and 94 corresponding to gated phase-sensitive detection and ungated phase-sensitive detection, respectively. The abscissa 96 represents the concentration of fluorophores in the sample in nanomolar concentration, and the ordinate 98 represents the S/N detected by the detector for the two different detections. As illustrated, the detectable S/N value 98, that is S/N of about 3 is observed for a concentration 100 of less than about 1 nanomolar of fluorophore for gated phase-sensitive detection, whereas, for ungated phase-sensitive detection, the detectable S/N is observed at a higher concentration 102 of about 9 nanomolar.

Fluorescence spectroscopy using gated phase-sensitive detection is a low cost solution for high S/N for very small sample concentrations. Although the present examples are related to microfluidic samples, similar detection methods and systems may be adapted for other applications.

While only certain features of the invention have been illustrated and described herein, many modifications and changes will occur to those skilled in the art. It is, therefore, to be understood that the appended claims are intended to cover all such modifications and changes as fall within the scope of the invention.

1. A microfluidic detection system, comprising:
a device for illuminating a microfluidic sample comprising an analyte, wherein illumination from the illuminating device is modulated on and off at a determined frequency;
a gated phase-sensitive detector that detects, one or more wavelengths emitting from the analyte, at a determined frequency; and
a control device that coordinates the modulating frequency of the illumination and the detecting frequency of the detector.

2. The microfluidic detection system of claim 1, wherein the illuminating device modulates on and off at a determined frequency.

3. The microfluidic detection system of claim 1, comprising an intermittent illumination device to at least partially interrupt the illumination from the illuminating device.

4. The microfluidic detection system of claim 1, wherein the gated phase-sensitive detector comprises a photodiode or a CCD and a lock-in amplifier.

5. The microfluidic detection system of claim 1, wherein the detection frequency is determined at least in part based on the frequency of modulation of the illuminating device.

6. The microfluidic detection system of claim 5, wherein the detector detects only when the illuminating device is off.

7. The microfluidic detection system of claim 6, wherein the illuminating device illuminates along a direction line and wherein the detector detects, at least in part, along a direction line that is in-line with the illuminating device's direction line.

8. The microfluidic detection system of claim 1, wherein the illuminating device comprises a laser, a light emitting diode (LED), a fluorescent lamp, or combinations thereof.

9. The microfluidic detection system of claim 8, wherein the photodiode is an avalanche photodiode.

10. The microfluidic detection system of claim 8, wherein a rise time of the photodiode is in a range from about 2 nanoseconds to about 5 nanoseconds

11. The microfluidic detection system of claim 1, wherein a sensivity of the gated phase-sensitive detector is greater than about 50 nanovolts.

12. The microfluidic detection system of claim 1, wherein the detector is in a direction of excitation of the analyte.

13. A microfluidic detection system for detecting a signal corresponding to an analyte, comprising:
a device for illuminating a microfluidic sample comprising an analyte, wherein illumination from the illuminating device is modulated on and off at a determined frequency;
a gated phase-sensitive detector that detects one or more wavelengths emitting from the analyte at a determined frequency; and
a control device that coordinates the modulating frequency of the illumination and the detecting frequency of the detector.

14. The microfluidic detection system of claim 13, wherein a concentration of analyte is greater than or equal to about 3 nanomolar.

15. The microfluidic detection system of claim 13, wherein a signal to noise ratio is enhanced by a factor in a range from about 3 to about 10.

16. A detection system for detecting a signal corresponding to an analyte, comprising:
a sample support comprising a sample detection zone;
a device for illuminating the sample in the detection zone, wherein the illuminating devices modulates on and off; and
a gated phase-sensitive detector for detecting the signal at a determined frequency when the illuminating device is off.

17. The detection system of claim 16, further comprising a control device that coordinates the modulation of the illuminating device and the detecting frequency of the detector based at least in part on a determined time delay interval between when the illumination source is on and when the detector begins detecting.

18. The detection system of claim 17, wherein the determined time delay interval is about 1 nanosecond to about 2.5 nanoseconds.

19. The detection system of claim 16, further comprising a low-wavelength pass optical filter disposed between the sample detection zone and the detector.

20. The detection system of claim 16, wherein at least one of the analyte is coupled to a phosphor dye.

21. The detection system of claim 16, wherein the sample support comprises a microfluidic device.

22. The detection system of claim 16, wherein the gated phase-sensitive detector comprises a heterodyne lock-in amplifier.

23. A method for signal detection of an analyte in a sample provided on a support, comprising:
illuminating the sample;
ceasing illumination of the sample after a determined time interval; and
after a time delay period, begin detecting a signal emitted from the sample at one or more lock-in detection frequencies.

24. The method of claim 23, further comprising filtering the signal emitted from the sample.

25. The method of claim 23, wherein the sample comprises a fluorescent probe and wherein the determined time interval is greater than or equal to a fluorescence lifetime of the fluorescent probe.
